(19) United States
(12) Patent Application Publication
(10) Pub. No.: US 2005/0114546 A1
(43) Pub. Date: May 26, 2005

(54) Method for establishing virtual intranet over internet based on a digital closed network constructed from a telephone exchange and a key telephone system and the virtual intranet structure using the same

(76) Inventor: Heng-Chien Chen, Taipei (TW)

Correspondence Address: NORTH AMERICA INTERNATIONAL PATENT OFFICE (NAIPC), P.O. BOX 506, MERRIFIELD, VA, 22116, US

(21) Appl. No.: 10/719,535

(22) Filed: Nov. 20, 2003

(51) Int. Cl. G06F 15/16

(52) U.S. Cl. 709/245

(57) ABSTRACT

An establishing virtual intranet based on a digital closed network constructed from a network PBX and a plurality of extensions, wherein the network PBX stores extension numbers, virtual IP address and a published IP address. Each extension will obtain an own extension number, virtual IP address and published IP address when the extension is connected to the network PBX. The extension registered to the network PBX is able to link to the network PBX when the registered extension is connected to Internet and uses the published IP address as a destination IP address. Therefore, the distant registered extension and the network PBX connected with multiple extensions construct a virtual Intranet over the Internet.

### BACKGROUND OF THE INVENTION

1. Field of the Invention

The invention is related to a virtual intranet based on a digital closed network, and more particularly to a virtual intranet which is established by the digital closed network over the Internet.

2. Description of the Prior Art

Since the VoIP (Voice over Internet Protocol) has the advantage of lower communication cost compared to the conventional telephone system and has the ability to integrate data, more and more enterprises employ the VoIP as their communicating means. Based on the established VoIP, the enterprise can simultaneously perform the voice, data and video signal transmission over the single IP platform. Therefore, not only is the internet management process simplified, but also the entire cost is reduced. With reference to FIG. 8, a local area network (LAN) integrated with a telephone exchange system is mainly composed of hubs (70), computers (71) and a telephone exchange (72), wherein each hub (70) is further connected with extensions (73). As shown in FIG. 9, a hub (70) is connected to a plurality of computers (71), wherein some specific computers (71) are respectively connected with the telephone exchange (72) and the extension (73).

In the intranet architecture mentioned above, the extension (73) only occupies a part of bandwidth (for example, 4K) for voice signal transmission. However, whether using the conventional IP network or the LAN, the data signal (data packet) is the main transmission subject. The objective of the network architecture design still focuses on the improvement of the reliability, i.e. to make the data packet have the highest transmission priority during the transmission process. In such a condition, when a great amount of data is transmitted among these computers (71), the serious problems of voice signal transmission delay and jitter accordingly arise. However, for voice signals, the most essential requirement is immediate transmission (i.e. the real time transmission). Therefore, the poor transmission quality is obvious.

Since the conventional intranet configuration is unable to solve the delay problem of signal transmitting, one temporary way to improve the voice signal transmission quality and to alleviate the problem is by utilizing the broad bandwidth. However, when a great quantity of data is being transmitted, these data still cause delay to the voices and such a temporary solution is unable to completely overcome the problem. Besides, the intranet architecture mentioned above is composed of the computers, the hub, the extensions to transmit data and voice signals so the extensions are limited in this intranet architecture to communicate with each other. That is, no one extension can communicate with others in the same Internet configuration.

To overcome the shortcomings, a virtual intranet based on the digital closed network in accordance with the present invention obviates or mitigates the foregoing mentioned problems.

### SUMMARY OF THE INVENTION

The primary objective of the present invention is to provide a virtual intranet based on the digital closed network, which is constructed by a network PBX and a key telephone system (KTS) to allow extensions that transmit the voice, data and video signals over the Internet or other LAN, MAN etc IP networks back to the other extensions, and still retain the superior voice transmission quality.

To achieve the objective, the virtual intranet is constructed of the network PBX, multiple extensions connected to the network PBX, wherein the network PBX and each telephone respectively have connection to an IP network capability to transmit IP packages over the IP network.

Each extension has a unique number, which is stored in the network PBX. The network PBX stores extension numbers, virtual IP addresses and at least one published IP address, and is set up with an identification method for automatically setting up extension numbers, virtual IP addresses and the published IP address to every extension connected to the network PBX. Therefore, when the registered extension is brought to another place the registered extension can be connected to a modem or an XDSL to link to the Internet. The registered extension stores the published IP address of the network PBX so the registered extension uses the published IP address to link back to the network PBX through the Internet. Therefore, the distant registered extension and the network PBX are constructed via the virtual Intranet.

Other objectives, advantages and novel features of the invention will become more apparent from the following detailed description when taken in conjunction with the accompanying drawings.

### BRIEF DESCRIPTION OF THE DRAWINGS

FIG. 1 is a function block diagram of a first embodiment of a virtual intranet having a digital closed network configuration over the Internet in accordance with the present invention;

FIGS. 2A-2C are schematic topologies showing a network PBX (private branch exchange) connected to a plurality of extensions in accordance with the present invention;

FIG. 3 is a block diagram of the digital closed network configuration of the first embodiment in accordance with the present invention;

FIG. 4 is a function block diagram of a second embodiment of a virtual intranet having a digital closed network configuration over the Internet in accordance with the present invention;

FIG. 5 is a block diagram of the digital closed network of the second embodiment in accordance with the present invention;

FIG. 6 is a connection schematic view showing a small virtual intranet having one network PBX;

FIG. 7 is a connection schematic view showing a large virtual intranet having multiple network PBX connected with each others;

FIG. 8 is a function block diagram of a conventional network configuration; and

FIG. 9 is a further function block diagram of a conventional network configuration.

### DETAILED DESCRIPTION OF THE PREFERRED EMBODIMENT

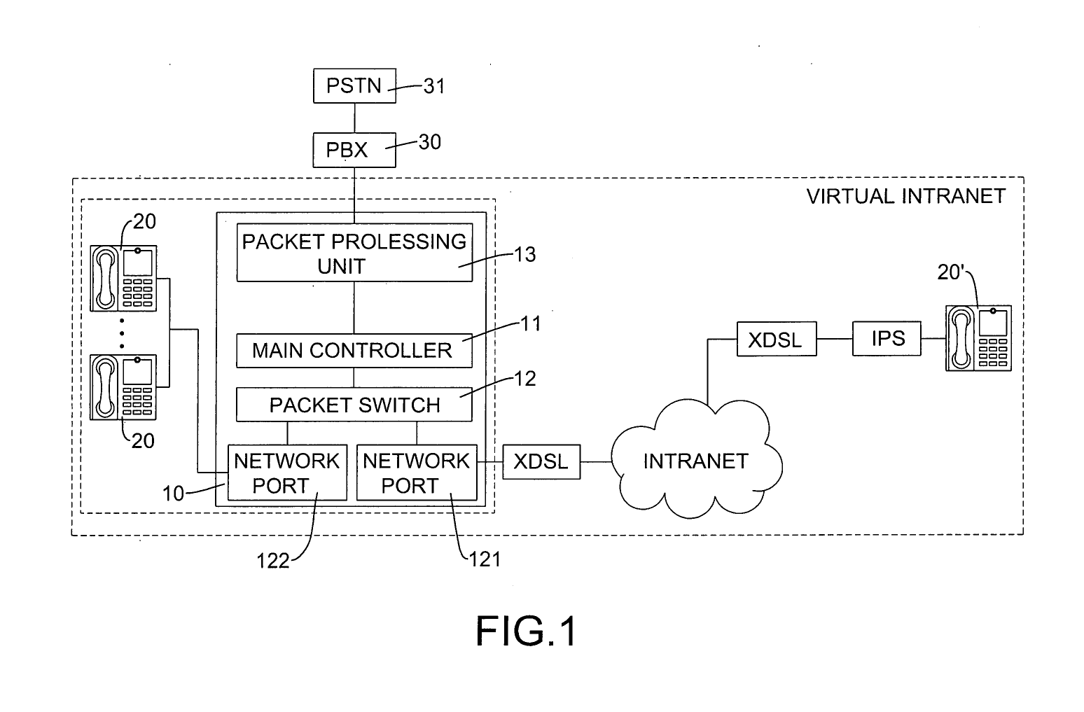

With reference to FIG. 1, a closed network in accordance with the present invention comprises at least one network telephone exchange (private branch exchange, PBX)(10), and a key telephone system (KTS) composed of a plurality of extensions (20).

The network PBX (10) includes a main controller (11) and a packet switch (12). The packet switch (12) has at least two network ports (121, 122) for the IEEE 802.3 protocol to connect the extensions (20). The main controller (11) connected to the packet switch (12) stores multiple extension numbers for the extensions (20) and is set up with an identification method. The main controller (11) further stores multiple virtual IP addresses corresponding to each extension number. The network PBX (10) further comprises a packet processing unit (13) for two-way converting connected between the main controller (10) and an extra PBX (30) for PSTN (31). The packet switch (11) is set up with at least one published IP address for linking to the Internet through one network port (121) connected to a network device (not numbered) as a modem or an XDSL (not numbered).

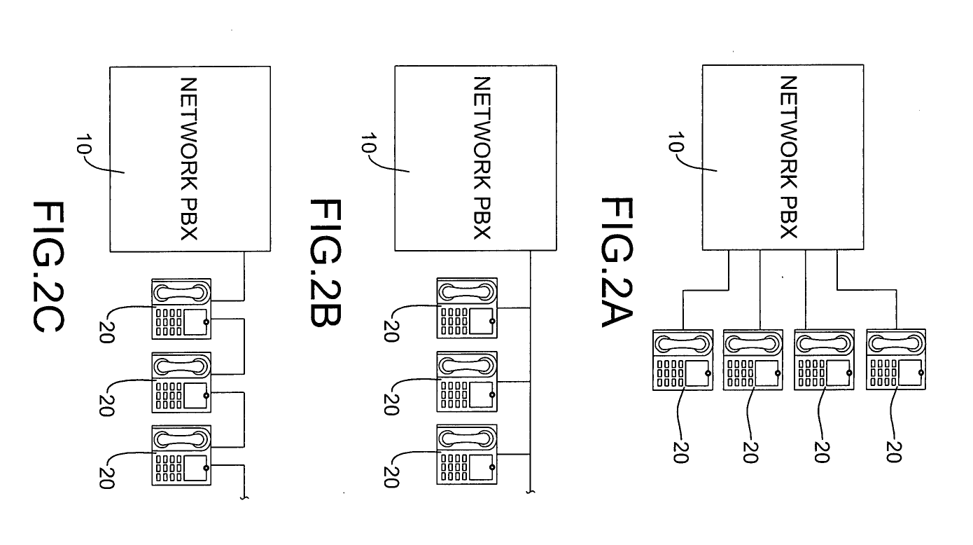

The plurality of extensions (20) is able to connect to the network port (122) of the network PBX (10) with different topologies (as shown in FIGS. 2A-2C) so as to construct a closed network for voice, data and video transmitting. The extensions (20) are able to communicate with each other through the network PBX (20).

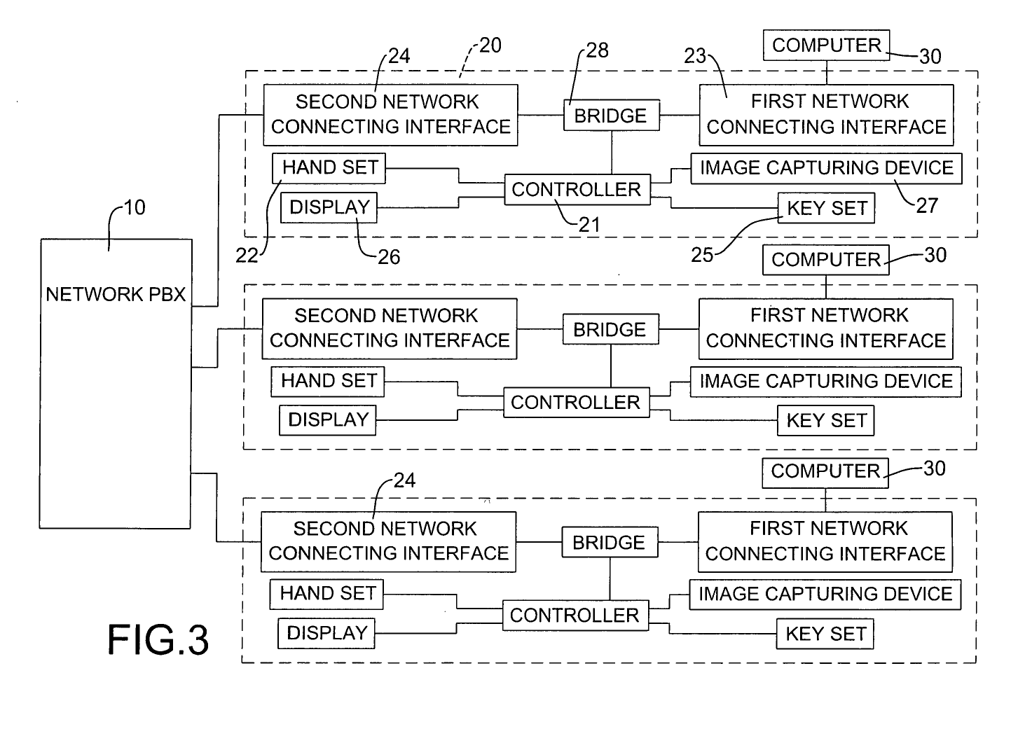

With reference to FIG. 3, each extension (20) further includes:
a controller (21) with a two-way converting function, wherein the controller (21) is able to convert voice signals to the form of voice packets, and is able to restore the voice packets to the voice signals, wherein the controller (21) stores an own extension number and the own virtual IP address from the main controller (shown in FIG. 1) and the published IP address;
a handset (22) to receive voice signals from a user and then transmit to the controller (21), or to broadcast voice signals output from the controller (21);
a first network connecting interface (23) connecting between the controller (21) and the network device (30), wherein the first network connecting interface (23) follows the IEEE 802.3 protocol so the network connecting interface (23) is for connection with a network interface card for IEEE 802.3 protocol installed in an extra network device (30);
a second network connecting interface (24) connecting between the controller (21) and the network port (shown in FIG. 1) of the network PBX (10);
a key set (25) connected to the input terminals (not numbered) of the controller (21) for the use of dialing or parameters setting;
a display (26) connected to the output terminal of the controller (21) to display messages or video images; and
an image capture device (27), such as a CCD (Charge-Coupled Device) camera, connected to the input terminal of the controller (21) for the use of image capture, wherein the captured images are then processed to become the form of video packets by the controller (21) for further transmission.

Each extension (20) further includes a bridge (28) linked between the first network connecting interface (23) and the second network connecting interface (24) to perform the transmission flow control of the closed network.

From the foregoing description of the network architecture, the plurality of extensions (20) not only constructs the closed network in company with one network PBX (10), but each extension (20) is also used as an intermediary node that allows the personal computer, hub, network printer etc. to communicate with the closed network.

When the closed network is constructed, each extension (20) stores its own extension number, virtual IP address and the published IP address. Therefore, an establishing virtual intranet method includes the steps of:
(a) registering each extension to the telephone exchange so that each extension has an own extension number and the published IP address;
(b) connecting at least one distant registered extension to an extra network device such as a modem or XDSL;
(c) linking at least one registered extension back to Internet by the network device;
(d) using the published IP address as a destination IP address in IEEE 802.3 package; and
(e) linking at least one registered extension back to the network PBX.

With further reference to FIG. 1, when the distant registered extension (20) links to the network PBX (10) over the Internet (not numbered), the virtual intranet is constructed, wherein the virtual intranet includes the Internet. In such a virtual intranet, the distant registered extension (20′) can dial a specific extension number of one extension (20) connected to the network PBX (10) to establish a point to point connection over the Internet. Thus, a company salesperson can bring one of the registered extensions (20′) to anywhere. The salesperson only has to connect the registered extension (20′) as a distant registered extension to the Internet and then can make a call back to the company for talking or transmitting digital data.

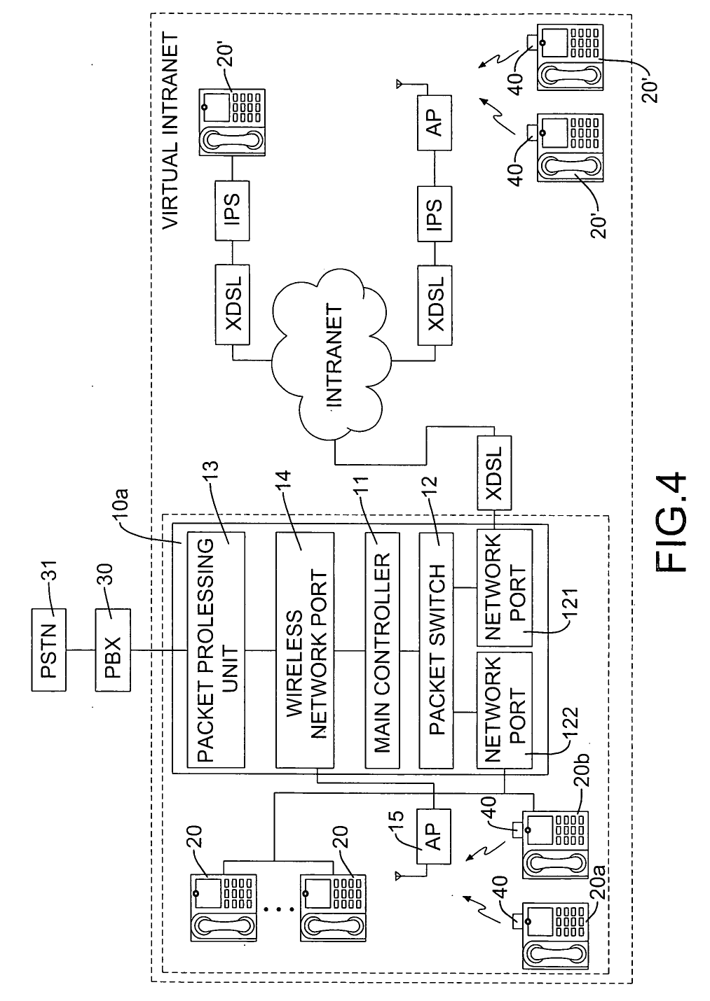

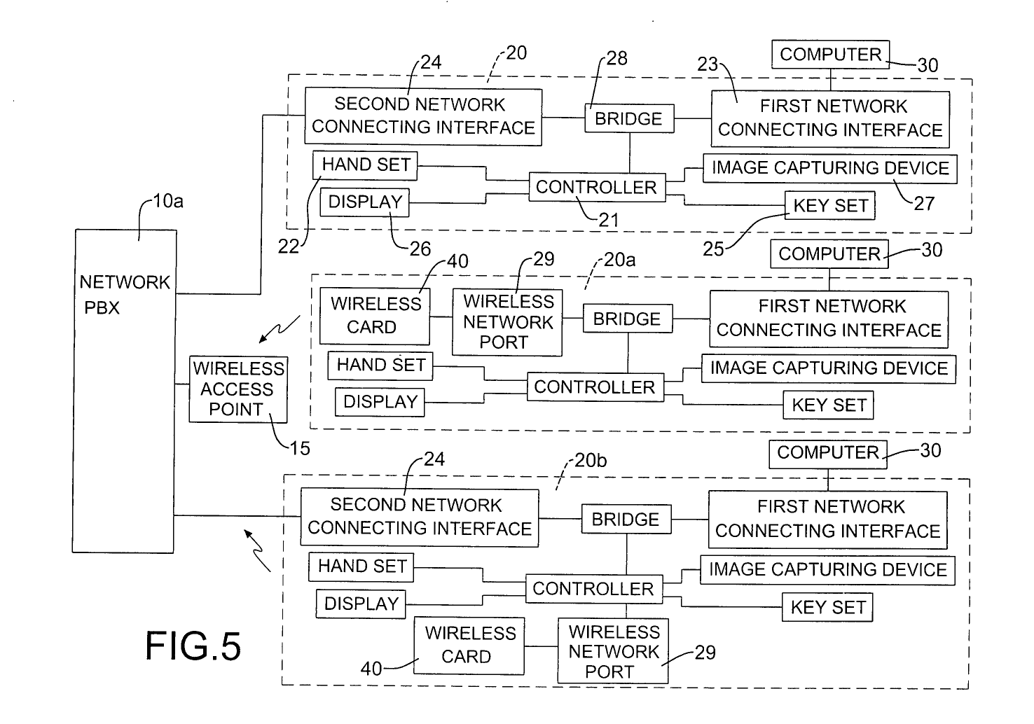

With reference to FIG. 4, a second embodiment of the present invention is similar to the first embodiment. The main controller (11) of the network PBX (10a) is further connected to a wireless port (14) for the IEEE 802.11x protocol. Therefore, the network PBX (10a) is further connected to an extra wireless Access point (AP). With reference to FIG. 5, multiple wireless extensions (20a, 20b) are used in place of some of the extensions (20) in the first embodiment. One kind of wireless extension (20a) is similar to the extension (20) in the first embodiment and only further has a wireless network port (29) for a wireless card (40). The wireless network port (29) and the wireless card (40) are used in place of the second network connecting interface (24). Another wireless extension (20b) is similar to the extension (20) and only further includes a wireless network port (29) and a wireless card (40) so the wireless extension can link to the network PBX (10a) through the second network connecting interface (24) or the wireless card (40). The wireless extension (20a, 20b) links to the network PBX (10) by the wireless card (40) and the wireless AP (15).

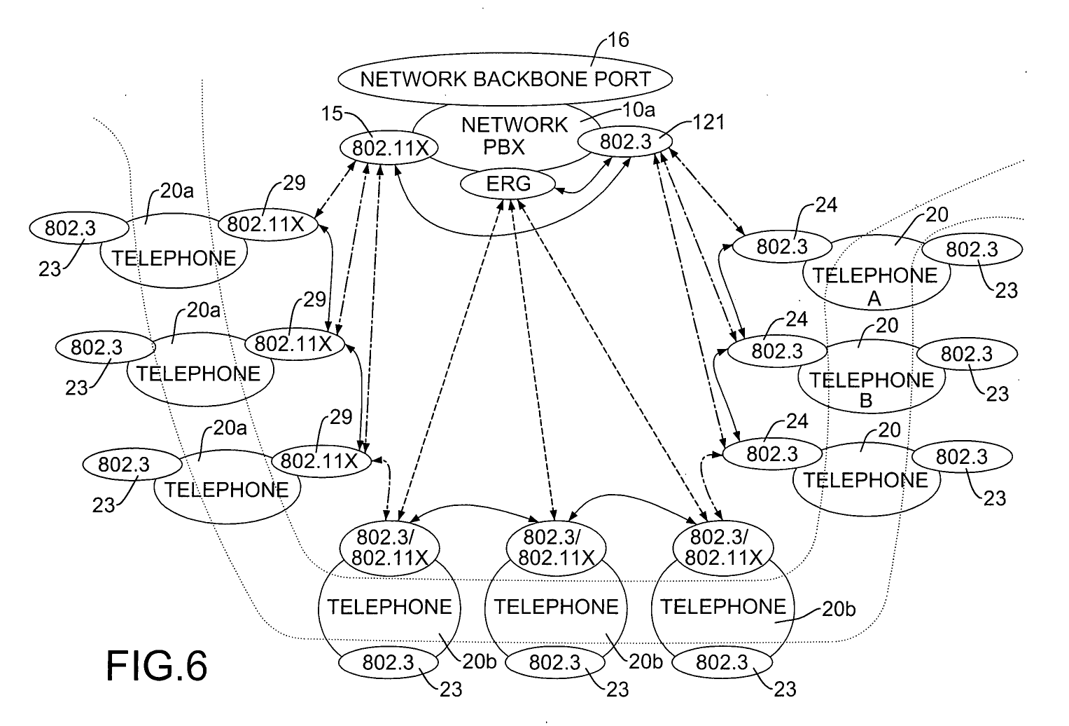

With reference to FIG. 6, the network PBX (10) has all extension numbers so any one extension (A) required to connect to one or more extensions (20) can do so by sending a requirement package including the extension number of the specific extension (B) to network PBX (10). When the network PBX (10) receives the requirement package (denoted by a broken line between the network PBX (10) and the extension (A)), the main controller (11) will execute the identification method to check whether the specific extension (B) is online (denoted by a broken line between the network PBX (10) and the extension (B)). If the specific extension (B) is online the main controller (11) is able to notify the specific extension (B) of the virtual IP address of the extension (A) that sent the requirement package. The specific extension (B) can connect to the extension to establish a connection by the virtual IP address of the extension (A) (denoted by a curved line between the extension (A) and the specific extension (B)). The network PBX (10) is also able to send back the virtual IP address of the specific extension (B) to the extension (A) after the network PBX (10) ensures the specific extension online (B). Therefore, the extension (A) can connect directly to the specific extension (B) by the virtual IP address of the specific extension (B).

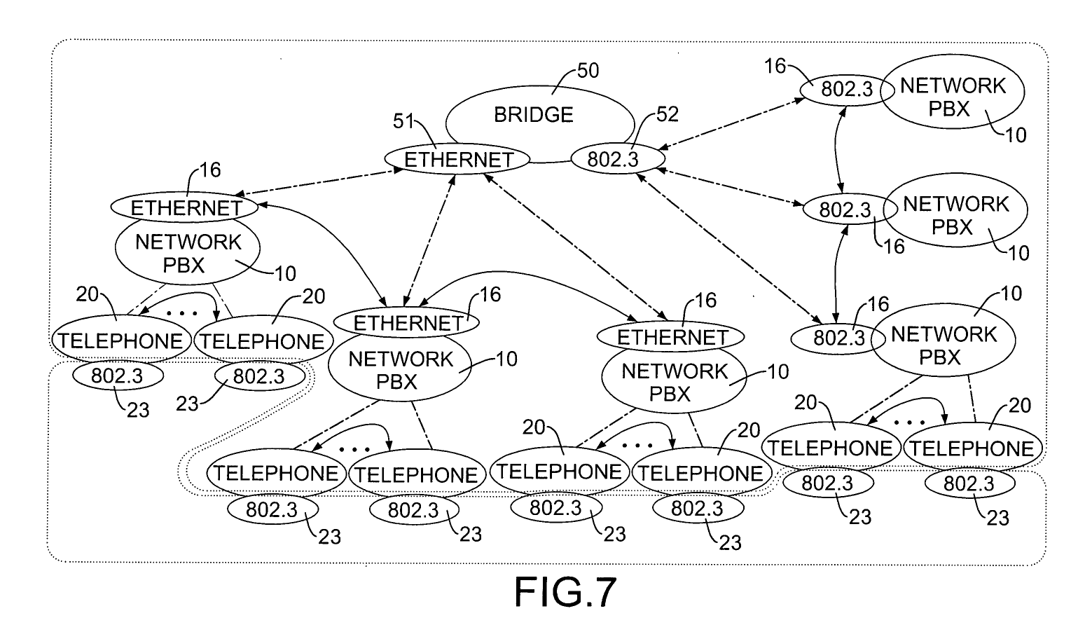

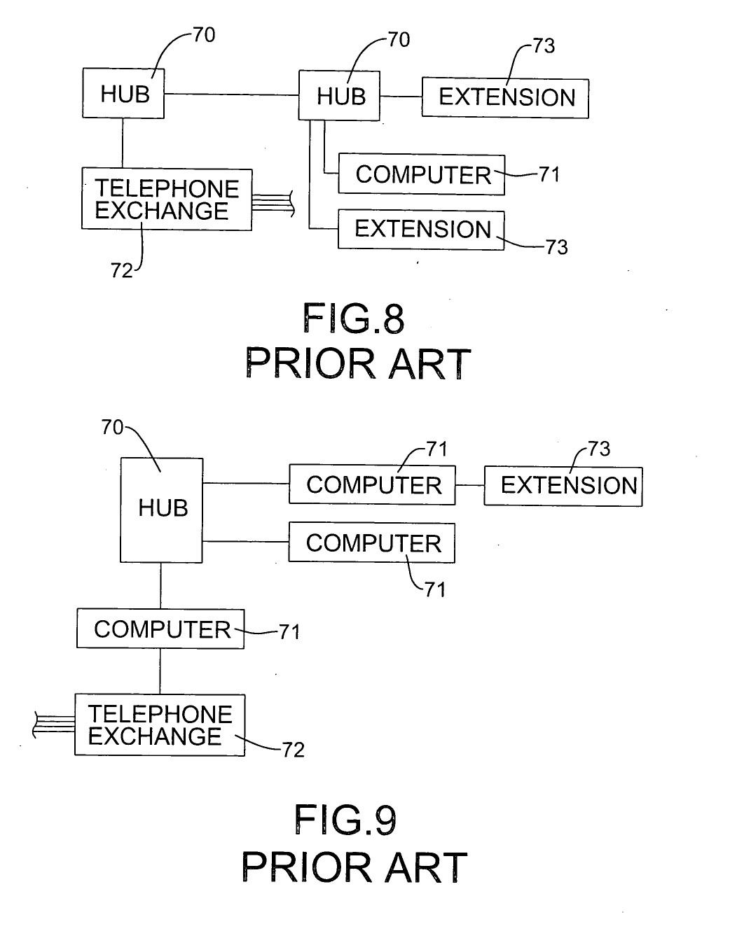

With further reference to FIG. 7, to enlarge a range of the virtual intranet, at least two network PBXs (10) are connected to a common main bridge (50) based on the fiber optical network for IEEE 802.3 protocol or Ethernet backbone. That is, each main controller (1) further comprises a network backbone port (16) and the bridge (50)-has at least two different network ports (51) (52) for Ethernet or IEEE 802.3 protocol. The network backbone port (16) is connected to the corresponding network port (51) of the bridge (50) through the Ethernet backbone or IEEE 802.3 backbone. Therefore, the bridge (50) is a central network switch to exchange packages in different network PBXs (10).

One special point that needs to be noted is when the voice signal is communicating over the closed network, the network will provide superior transmission quality. For example, if one extension (20) is used as a transmitter (the voice source), the input voice from the handset (22) is converted to the form of voice packets by the controller (21) and then transmitted over the closed network. After another extension (20), which acts as a voice receiver, receives and converts the voice packet to a voice signal by the controller (21), the voice signal is then broadcasted via the handset (22). Since the voice is transmitted in the form of voice packets, the problems of transmission delay and jitter are accordingly overcome. Moreover, by controlling the controller (21) and the bridge (28) to properly set the transmission priority among the voice packets, data packets and the video packets, the transmission quality is able to be further improved. In other words, because of the controllable transmission flow in the closed network, the real time voice transmission is assured.

In conclusion, the present invention providing a virtual intranet differs from the conventional the intranet limited in a specific place and together with the telephone system having packet conversion ability and bridge function collectively provides an immediate voice transmission, wherein the problems of delay and jitter are avoided. In addition, the network architecture of the present invention also meets the data transmission protocol (IEEE 802.3/302.11 x) to ensure that the data/video packets are correctly transmitted among all nodes of the network. In other words, the present invention still retains the high reliability for data/video transmission.

The invention may be varied in many ways by a skilled person in the art. Such variations are not to be regarded as a departure from the spirit and scope of the invention, and all such modifications are intended to be included within the scope of the following claims.

1. A method of establishing a virtual intranet over the Internet based on a digital closed network constructed from at least one network private branch exchange (PBX) having an identification method and storing at least one published IP address, extension numbers and virtual IP addresses corresponding to the extension numbers; and a key telephone system that is composed of a plurality of extensions (20), the method comprising the steps of:
registering each extension to the telephone exchange whereby each extension has an own extension number and the published IP address;
linking at least one registered extension to the Internet;
using the published IP address as a destination IP address; and
linking at least one registered extension back to the network PBX;
whereby the at least one registered extension and the network PBX connected to multiple other extensions are constructed to the virtual intranet over the Internet.

2. The method as claimed in claim 1, in the linking at least one registered extension to the Internet step the at least one registered extension links to the Internet through a network device

3. The method as claimed in claim 2, wherein the network device is a modem.

4. The method as claimed in claim 2, wherein the network device is an XDSL.

5. The method as claimed in claim 1, wherein in the linking at least one registered extension to the Internet step the at least registered extension links to Internet through a wireless network device linked to the Internet.

6. The method as claimed in claim 1, the network PBX further having a function of two-way converting, wherein the telephone exchange converts external voices signals from the network PXB connected to PSTN to a form of voice packets or to restore the voice packets to the voice signals.

7. A virtual intranet comprising:
one network private branch exchange (PBX) having a voice packet converting and restoring function, wherein the network PBX stores extension numbers, virtual IP addresses respectively corresponding to each extension number and at least one published IP address and is set up as an identification method; and
multiple extensions connected to the network PBX to form the closed network, whereby voice, data and video are able to be transmitted over the closed network, wherein each extension obtains an own extension number, the virtual IP address and the published IP address from the identification method when the extension is connected to the network PBX;
whereby each extension is able to link to the network PBX over the Internet when the extension links to Internet by using the published IP address as a destination IP address.

8. The virtual intranet as claimed in claim 7, wherein the network PBX comprises:
a main controller stored with multiple extension numbers, the virtual IP address and set up with the identification method; and
a packet switch having at least two network ports for IEEE 802.3 protocol to connect the extensions, wherein the packet switch is set up with the published IP address.

9. The virtual intranet as claimed in claim 8, wherein the network PBX further comprises a packet processing unit for two-way converting connected between the main controller and an extra PBX for PSTN.

10. The virtual intranet as claimed in claim 8, wherein each extension comprises:
a controller with the two-way converting function, wherein the controller is able to convert voice signals to the form of voice packets, and is able to restore the voice packets to the voice signals; wherein the controller stores an own extension number and the own virtual IP address from the main controller and the published IP address;
a handset transmitting received voice signals to the controller, wherein the handset is able to broadcast voice signals output from the controller;
a first network connecting interface connecting between the controller and one of the network device; and
a second network connecting interface connecting between the controller and the network PBX.

11. The virtual intranet as claimed in claim 10, wherein the first network connecting interface is connected to the network device through a network interface card installed in a network device.

12. The virtual intranet as claimed in claim 11, wherein each extension further comprises a bridge connected between a first network connecting interface and the second network connecting interface to control transmission flow.

13. The virtual intranet as claimed in claim 10, wherein the controller further connects to a display, a key set and an image capturing device.

14. The virtual intranet as claimed in claim 9, wherein the network PBX further comprises at least one wireless network port for connecting to at least one wireless access point.

15. The virtual intranet as claimed in claim 14, wherein each extension comprises:
a controller with the two-way converting function, wherein the controller is able to convert voice signals to the form of voice packets, and is able to restore the voice packets to the voice signals; wherein the controller stores an own extension number and the own virtual IP address from the main controller and the published IP address;
a handset transmitting received voice signals to the controller, wherein the handset is able to broadcast voice signals output from the controller;
a first network connecting interface connecting between the controller and one of the network devices; and
a wireless network port for a wireless card connected between the controller and the wireless access point.

16. The virtual intranet as claimed in claim 15, wherein each extension comprises a second network connecting interface connecting between the controller and the network PBX.

17. The virtual intranet as claimed in claim 15, wherein the first network connecting interface is connected to the network device through a network interface card installed in a network device.

18. The virtual intranet as claimed in claim 15, wherein each extension further comprises a bridge connected between a first network connecting interface and the second network connecting interface to control transmission flow.

19. The virtual intranet as claimed in claim 15, wherein the controller further connects to a display, a key set and an image capturing device.

20. The virtual intranet as claimed in claim 8, wherein the main controller further comprises a network backbone port for connecting a bridge through an Ethernet backbone.
